(19) United States
(12) Patent Application Publication
(10) Pub. No.: US 2020/0028535 A1
(43) Pub. Date: Jan. 23, 2020

(54) METHOD AND APPARATUS FOR TRANSPORTING A MOBILE PHONE

(71) Applicant: Mary Kay McGRATH, Cedar Rapids, IA (US)

(72) Inventor: Mary Kay McGRATH, Cedar Rapids, IA (US)

(21) Appl. No.: 16/519,792

(22) Filed: Jul. 23, 2019

Related U.S. Application Data
(60) Provisional application No. 62/702,130, filed on Jul. 23, 2018.

(51) Int. Cl. H04B 1/3888; H04M 1/04; A45C 11/00; A45F 5/00

(52) U.S. Cl. CPC H04B 1/3888; H04M 1/04; A45C 11/00; A45F 2005/006; A45C 2011/002; A45F 2200/0516; A45F 5/00

(57) ABSTRACT

A multipurpose mobile phone carrying system with an elongated strap, a first swivel assembly, a second swivel assembly, configured to couple with a mobile phone housing; a first strap length adjuster and second strap length adjuster, which are configured for relative translational movement therebetween to reconfigure said system from a shoulder strap, waist belt, to a neck lanyard.

### CROSS REFERENCE TO RELATED APPLICATIONS

The present application claims the benefit of the filing date of provisional patent application having Ser. No. 62/702,130 filed on Jul. 23, 2018, which application is incorporated herein in its entirety by this reference.

### FIELD OF THE INVENTION

The present invention generally relates to mobile telephones, and more particularly, relates to method and apparatus for transporting a mobile phone, and, even more particularly, relates to adjustable multi-purpose sling for providing multiple mobile phone carrying options from a single use device.

### BACKGROUND OF THE INVENTION

In the past, various devices for conveniently carrying mobile phones have been used in a wide variety of applications.

While these types of mobile phone transporting devices may have many advantages in particular applications, they also have some drawbacks. For example, in many such mobile phone carrying systems, these devices are often too difficult to change a configuration to accommodate changes in use or discomfort caused by prolonged use.

Consequently, there exists a need for improved methods and apparatuses for efficiently and definitively adjusting a mobile phone carrying system between multiple predetermined use characteristics.

### SUMMARY OF THE INVENTION

It is an object of the present invention to provide an easily implemented system for changing a mode of carrying a mobile phone.

It is a feature of the present invention to provide a strap with a first strap length adjuster and a second strap length adjuster where relative translational motion therebetween results in reconfiguration of the system between predetermined use characteristics.

It is an advantage of the present invention to provide for a method and system for reducing the amount of mobile phone carrying systems needed during times of long use and variation of use between multiple uses.

The present invention is an apparatus and method for efficiently and cost effectively providing the ability to easily reconfigure a mobile phone carrying system to accommodate varied uses, which apparatus and method are designed to satisfy the aforementioned needs, provide the previously stated objects, include the above-listed features, and achieve the already articulated advantages. The present invention is carried out in a “multiple device-less” manner, in a sense that need for carrying multiple phone carrying devices is greatly reduced.

Accordingly, the present invention is a method of transporting a mobile phone comprising the steps of:
providing an elongated strap;
threading a first strap end 211 of said elongated strap through the following:
   a first swivel strap loop 116;
   a first strap length adjuster 140, with a first strap length adjuster central bar 141;
   a second strap length adjuster 150, with a second strap length adjuster central bar 151;
   a second swivel strap loop 126;
   threading a first strap end 211 a second time up through and into said second strap length adjuster 150, over said second strap length adjuster central bar 151 and back down and out of said second strap length adjuster 150;
   folding said first strap end 211 back onto a first intermediate portion of said elongated strap which, when measured along a central longitudinal line of said elongated strap from said first strap end 211, is a closest portion to said first strap end 211 that has been threaded over said first strap length adjuster central bar 141 and has not been threaded over said second strap length adjuster central bar 151;
   creating a first joined strap terminal portion 210, by joining said first intermediate portion and a first portion adjacent to said first strap end 211;
   threading a second strap end 211 of said elongated strap, a first time up through and into said first strap length adjuster 140, over said first strap length adjuster central bar 141 and back down and out of said first strap length adjuster 140;
   folding said second strap end 211 back onto a second intermediate portion of said elongated strap which has not been threaded over said first strap length adjuster central bar 141;
   creating a second joined strap terminal portion 210, by joining said second intermediate portion and a second portion adjacent to said second strap end 211;
   adjusting a separation distance characteristic, along said elongated strap, of said first strap length adjuster 140 and said second strap length adjuster 150, to create a first configuration having a first predetermined use characteristic;
   coupling a mobile phone to said first swivel strap loop 116 and said second swivel strap loop 126 and using said first configuration in accordance with said first predetermined use characteristic;
   further adjusting said separation distance characteristic to create a second configuration having a second predetermined use characteristic; and
   using said second configuration in accordance with said second predetermined use characteristic.

Additionally, the present invention is a system transporting a mobile phone comprising:
an elongated strap; having a first strap end 211; a first swivel assembly 110;
a first strap length adjuster 140, with a first strap length adjuster central bar 141;
a second strap length adjuster 150, with a second strap length adjuster central bar 151; a second swivel assembly 120;

a first joined strap terminal portion 210;
a second joined strap terminal portion 210;
a mobile phone coupled to said first swivel assembly 110 and said second swivel assembly 120; and
a combination of said first strap length adjuster 140 and said second strap length adjuster 150 being configured so that adjusting a separation distance therebetween results in reconfiguration of said system between a first configuration having a first predetermined use characteristic, and a second configuration having a second predetermined use characteristic.

### BRIEF DESCRIPTION OF THE DRAWINGS

The invention may be more fully understood by reading the following description of the preferred embodiments of the invention, in conjunction with the appended drawings wherein:

FIG. 1 is a perspective view of the present invention.

FIG. 2 is a close up view of a portion of the system of FIG. 1 after first swivel assembly 110 has been unclipped from mobile phone case mounting plate annular member 16 and after the size of second strap loop 121 has been enlarged.

FIG. 3 is a view of the second strap loop 121 of FIG. 2.

FIG. 4 is a view of the present invention showing a sewn strap terminal portion 210.

FIG. 5 is a view of the present invention being worn as a belt.

FIG. 6 is a view of the present invention being worn as a shoulder strap with the phone being used.

FIG. 7 is a view of the present invention being worn as a shoulder strap and the phone is not in use.

FIG. 8 is a view of the present invention with the phone deployed for listening and speaking.

FIG. 9 is a view of the present invention showing the edge of the end portions of the strap when configured so that first strap loop 111 is small and second strap loop 121 is large.

### DETAILED DESCRIPTION

Although described with particular reference to mobile phones, the systems and methods of the present invention for transporting a mobile phone can be implemented with many different types of implements other than a mobile phone.

In an embodiment, the system and method of the present invention described herein can be viewed as examples of many potential variations of the present invention which are protected hereunder.

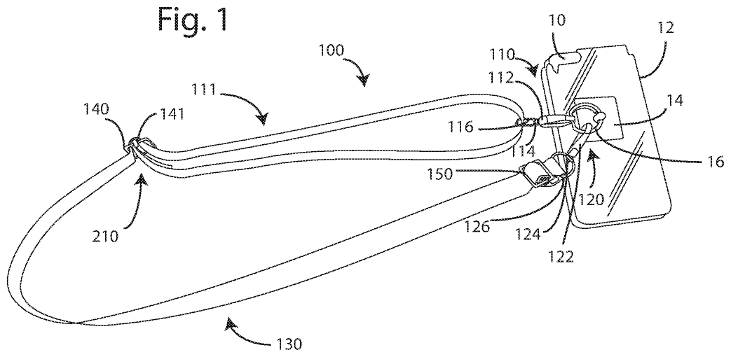

Now referring to the drawings wherein like numerals refer to like matter throughout, and more particularly FIG. 1, there is shown a diagram illustrating a representative version of the mobile phone sling strap 100 of the present invention which contains a mobile phone 10, mobile phone case 12, mobile phone case mounting plate 14, and mobile phone case mounting plate annular member 16. Mobile phone case mounting plate 14 and mobile phone case mounting plate annular member 16 could be made as a universal system, as shown configured to work with any phone case, or it could be made integral with the phone case. As shown, mobile phone case mounting plate 14 would be mounted to mobile phone case 12 using a strong adhesive. Mobile phone case mounting plate 14 is shown with a central portion for allowing mobile phone case mounting plate annular member 16 to be pivotably coupled thereto.

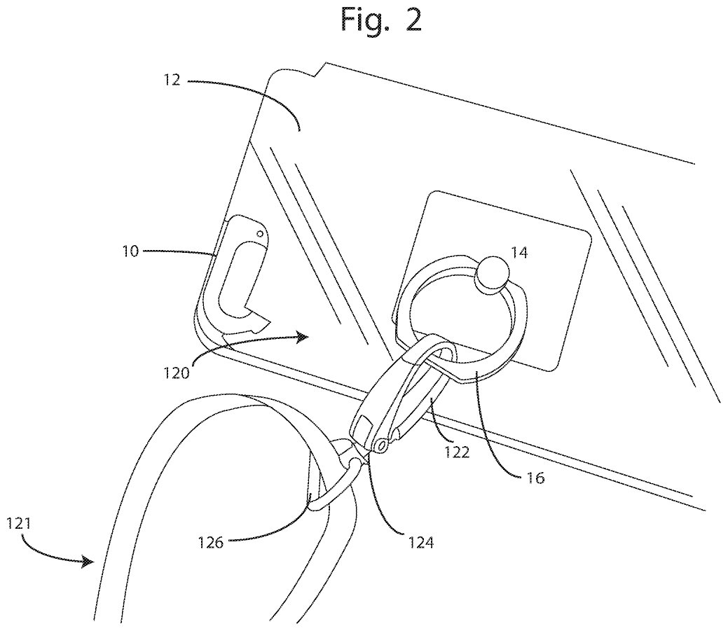

Also shown are first swivel assembly 110 and second swivel assembly 120 having been clipped to mobile phone case mounting plate annular member 16. First swivel assembly 110 is shown comprising first swivel clip 112, first swivel post 114, and first swivel strap loop 116. Similarly, second swivel assembly 120 is shown with second swivel clip 122, second swivel post 124, and second swivel strap loop 126. First strap loop 111 is shown large while second strap loop 121 (FIG. 2) is shown small. Each first strap loop 111 and second strap loop 121 are adjusted in length by moving first strap length adjuster 140 and second strap length adjuster 150, respectively, along central strap portion 130. Also shown is sewn strap terminal portion 210, which is a method of attaching the strap to a first strap length adjuster 140 by forming a fixed length small closed loop in the strap around first strap length adjuster central bar 141.

Now referring to FIG. 2, there is shown a close up portion of the second strap loop 121 portion of the present invention. The strap is clearly shown as passing through second swivel strap loop 126, which is how the strap is coupled to the second swivel assembly 120. Second swivel clip 122 is shown as a clip which can be open for coupling and decoupling from mobile phone case mounting plate annular member 16.

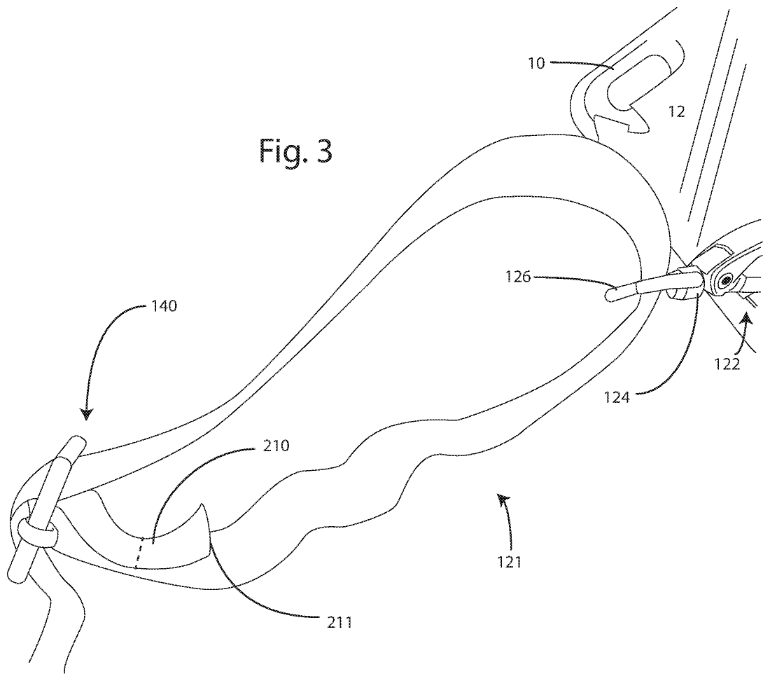

Now referring to FIG. 3, there is shown the strap end 211 which is adjacent to sewn strap terminal portion 210.

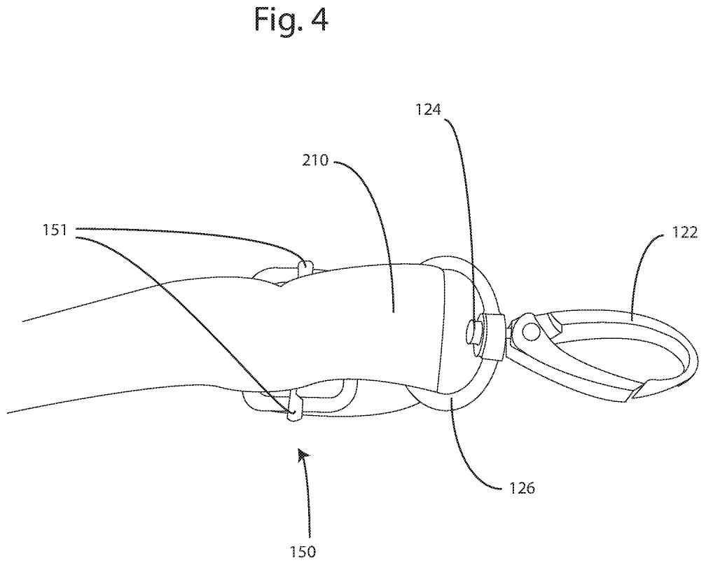

Now referring to FIG. 4, there is shown an additional view of the sewn strap terminal portion 210 used to couple the strap to the second strap length adjuster central bar 151.

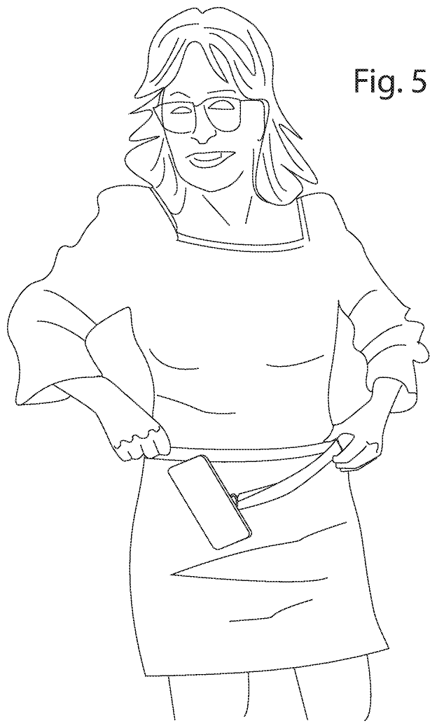

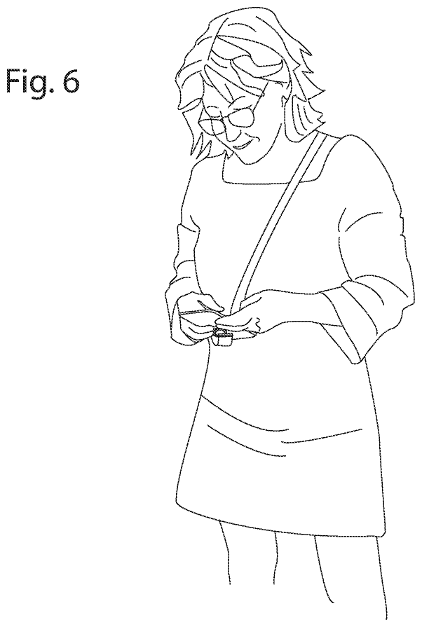

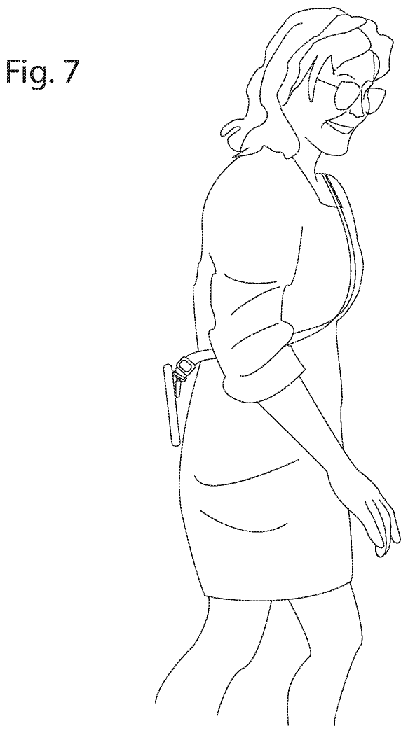

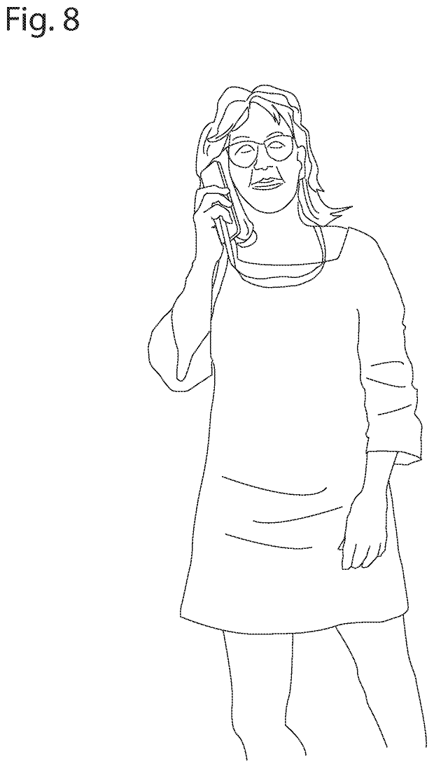

Now referring to FIGS. 5-8, the present invention is shown in different configurations of the first strap length adjuster central bar 141 and second strap length adjuster central bar 151 with respect to central strap portion 130 so as to facilitate several different uses.

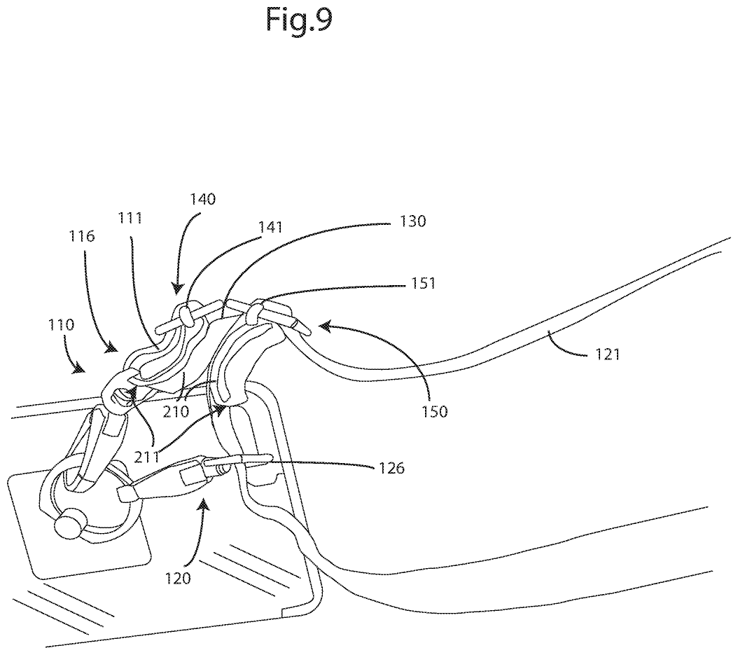

Now referring to FIG. 9, there is shown the present invention configured with a small first strap loop 111 and a large second strap loop 121. This view showing the edge of the strap with first strap length adjuster 140 and second strap length adjuster 150 being adjacent and resulting in an extremely small central strap portion 130. The attachments of the straps to first strap length adjuster 140 and second strap length adjuster 150 are shown each with a sewn strap terminal portion 210 and strap end 211.

All of the components of the present invention can be, if desired, purchased from many different vendors. In some applications, custom components would be preferable to optimize performance for that particular application.

Now referring to FIG. 9, one method of assembling the present invention could start with:

Proving an elongated strap;

Providing a first swivel assembly 110,

Sliding the first strap end 211 through the first swivel strap loop 116;

Inserting, from beneath the first strap length adjuster 140, the strap on one side of first strap length adjuster central bar 141, going over first strap length adjuster central bar 141 and back down through the remaining side of first strap length adjuster 140;

Repeating the step with second strap length adjuster 150 so that central strap portion 130 is underneath both adjacent ends of first strap length adjuster 140 and second strap length adjuster 150;

Passing the first strap end 211 through second swivel strap loop 126;

Passing the first strap end 211 from beneath up and over second strap length adjuster central bar 151, remaining under the portion of the strap which is over second strap length adjuster central bar 151;

Folding the strap back on itself and forming a small but, in many embodiments, not tightly around second strap length adjuster central bar 151 and creating a sewn strap terminal portion 210;

The remaining strap end 211 would be similarly folded back on itself and then similarly creating a second sewn strap terminal portion 210;

Both sewn strap terminal portions 210 could be trimmed as needed.

The precise implementation of the present invention will vary depending upon the particular application.

It is thought that the method and apparatus of the present invention will be understood from the foregoing description and that it will be apparent that various changes may be made in the form, construct steps and arrangement of the parts and steps thereof without departing from the spirit and scope of the invention or sacrificing all of their material advantages. The form herein described is merely a preferred exemplary embodiment thereof

1. A method of transporting a mobile phone comprising the steps of:
providing an elongated strap;
threading a first strap end of said elongated strap through the following:
a first swivel strap loop;
a first strap length adjuster, with a first strap length adjuster central bar;
a second strap length adjuster, with a second strap length adjuster central bar;
a second swivel strap loop;
threading a first strap end a second time up through and into said second strap length adjuster, over said second strap length adjuster central bar and back down and out of said second strap length adjuster;
folding said first strap end back onto a first intermediate portion of said elongated strap which, when measured along a central longitudinal line of said elongated strap from said first strap end, is a closest portion to said first strap end that has been threaded over said first strap length adjuster central bar and has not been threaded over said second strap length adjuster central bar;
creating a first joined strap terminal portion, by joining said first intermediate portion and a first portion adjacent to said first strap end;
threading a second strap end of said elongated strap, a first time up through and into said first strap length adjuster, over said first strap length adjuster central bar and back down and out of said first strap length adjuster;
folding said second strap end back onto a second intermediate portion of said elongated strap which has not been threaded over said first strap length adjuster central bar;
creating a second joined strap terminal portion, by joining said second intermediate portion and a second portion adjacent to said second strap end;
adjusting a separation distance characteristic, along said elongated strap, of said first strap length adjuster and said second strap length adjuster, to create a first configuration having a first predetermined use characteristic;
coupling a mobile phone to said first swivel strap loop and said second swivel strap loop and using said first configuration in accordance with said first predetermined use characteristic;
further adjusting said separation distance characteristic to create a second configuration having a second predetermined use characteristic; and
using said second configuration in accordance with said second predetermined use characteristic.

2. The method of claim 1 wherein said step of coupling a mobile phone further comprises providing a first swivel clip coupled to said first swivel strap loop through a first swivel post, a second swivel clip coupled to said second swivel strap loop through a second swivel post; and wherein first predetermined use characteristic is as a belt around a user's waist.

3. The method of claim 2 wherein said second predetermined use characteristic is a shoulder strap.

4. The method of claim 3 further comprising the steps of: further adjusting said separation distance to create a third configuration having a third predetermined use characteristic.

5. The method of claim 4 wherein said third predetermined use characteristic is as a neck lanyard.

6. The method of claim 5 further comprising the step of using said third configuration in accordance with said third predetermined use characteristic.

7. The method of claim 6 further comprising the steps of:
a. further adjusting said separation distance; and
b. removing one of said first swivel clip and said second swivel clip from connection with said mobile phone and making a connection therewith to a third intermediate portion of said elongated strap to create a fourth configuration and using said fourth configuration in a use which is not in accordance with any of said first predetermined use characteristic, said second predetermined use characteristic and said third predetermined use characteristic.

8. A system for transporting a mobile phone comprising:
an elongated strap; having a first strap end; a first swivel assembly;
a first strap length adjuster, with a first strap length adjuster central bar;
a second strap length adjuster, with a second strap length adjuster central bar; a second swivel assembly;
a first joined strap terminal portion;
a second joined strap terminal portion;
a mobile phone coupled to said first swivel assembly and said second swivel assembly; and
a combination of said first strap length adjuster and said second strap length adjuster being configured so that adjusting a separation distance therebetween results in reconfiguration of said system between a first configuration having a first predetermined use characteristic, and a second configuration having a second predetermined use characteristic.

9. The system of claim 8 further comprising: a mobile phone case, a mobile phone case mounting plate coupled to said mobile phone case, and a mobile phone case mounting plate annular member coupled to said mobile phone case mounting plate.

10. The system of claim 9 wherein said mobile phone is disposed in said mobile phone case.

11. The system of claim 10 wherein said mobile phone case mounting plate is coupled to said mobile phone case via an adhesive.

12. The system of claim 11 further comprising a pivoting connection between said mobile phone case mounting plate annular member and said mobile phone case mounting plate.

13. The system of claim 12 wherein said pivoting connection is also a rotating connection.

14. A system for transporting a mobile phone comprising:
an elongated strap; having a first strap end; a first swivel assembly;
a first strap length adjuster, with a first strap length adjuster central bar;
a second strap length adjuster, with a second strap length adjuster central bar; a second swivel assembly;
a first joined strap terminal portion;
a second joined strap terminal portion; a mobile phone coupled to said first swivel assembly and said second swivel assembly and a combination of said first strap length adjuster and said second strap length adjuster being configured so that adjusting a separation distance therebetween results in reconfiguration of said system between a first configuration having a first predetermined use characteristic, and a second configuration having a second predetermined use characteristic;
a mobile phone case, wherein said mobile phone is disposed in said mobile phone case;
a mobile phone case mounting plate coupled to said mobile phone case;
a mobile phone case mounting plate annular member coupled to said mobile phone case mounting plate;
wherein said mobile phone case mounting plate is coupled to said mobile phone case via an adhesive; and
a pivoting and rotating connection between said mobile phone case mounting plate annular member and said mobile phone case mounting plate.
